(19) United States
(12) Patent Application Publication
(10) Pub. No.: US 2003/0215683 A1
(43) Pub. Date: Nov. 20, 2003

(54) Fuel cell system

(76) Inventors: Rolf Bruck, Bergisch Gladbach (DE); Joachim Grosse, Erlangen (DE); Manfred Poppinger, Uttenreuth (DE); Meike Reizig, Bonn (DE)

Correspondence Address: LERNER AND GREENBERG, P.A., PATENT A TTORNEYS AND ATTORNEYS AT LAW, Post Office Box 2480, Hollywood, FL, 33022-2480, US

(21) Appl. No.: 10/426,526

(22) Filed: Apr. 30, 2003

Related U.S. Application Data
(63) Continuation of application No. PCT/DE01/04113, filed on Oct. 31, 2001.

(30) Foreign Application Priority Data
Oct. 31, 2000 (DE) 100 54 056.2

(51) Int. Cl. H01M 8/04; H01M 8/10; H01M 8/06

(52) U.S. Cl. 429/26; 429/32; 429/20

(57) ABSTRACT

A fuel cell system has at least one fuel cell module operating according to the HT-PEM principle. The novel installation renders harmless at least the excess hydrogen gas that accumulates on the hydrogen side of the individual fuel cell unit, by connecting an exhaust gas catalytic converter. Environmental pollution by hydrogen is thus prevented. The catalytic converter may also be enabled to purify carbon monoxide and/or hydrocarbons from the exhaust gas.

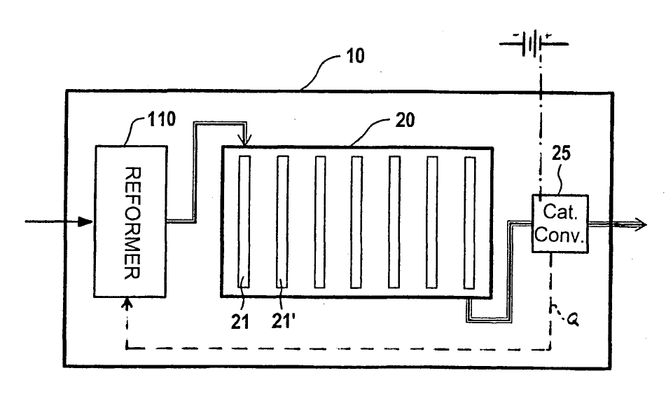

### CROSS-REFERENCE TO RELATED APPLICATION

This application is a continuation of copending International Application No. PCT/DE01/04113, filed Oct. 31, 2001, which designated the United States and which was not published in English.

### BACKGROUND OF THE INVENTION

### Field of the Invention

The invention lies in the fuel cell technology field. More specifically, the invention relates to a fuel cell system having at least one fuel cell module that is constructed as a polymer electrolyte membrane (PEM) fuel cell.

A fuel cell system with a PEM fuel cell module is known, for example, from U.S. Pat. No. 5,928,807 and European patent EP 0 774 794 B1. It has also become known to operate PEM fuel cell modules of that type at elevated temperatures, i.e. temperatures of over 60° C., as the standard operating temperature of the PEM fuel cell. In that case, the fuel cells are known as HT-PEM fuel cells (HT, high temperature). Such HT-PEM fuel cells are operated in a temperature window of between 60° C. and 300° C., in particular in a range from 120° C. to 200° C.

An earlier patent application, publication No. US 2002/0122963 A1 (published international PCT application WO 01/03222 A1), which is assigned to one of the assignees of the instant application and which was not published before the priority date of the present application, describes a fuel cell system with integrated gas purification and a process for purifying reformer gas in which in particular carbon monoxide is to be removed from the reformer gas. An exhaust-gas catalytic converter is used for that purpose. In this context, it is important for the PEM fuel cells, which are known to react sensitively to carbon monoxide, not to be subjected to impurities of this type. In addition, U.S. Pat. No. 6,232,005 and European patent EP 0 924 786 A2 describe a fuel cell system having a reformer for fuel in which there is a catalytic combustion device which is operated with anode and cathode exhaust gas. The assumption in this case is that as yet unreacted hydrogen may be present in the anode exhaust gas. Especially for use in PEM fuel cells, it is assumed that the levels of impurities in the fuel gas must only be low.

By contrast, a particular advantage of HT-PEM fuel cells is that operation of the fuel cell is insensitive to impurities in hydrogen (H₂) or hydrogen-rich fuel gas obtained from the fuel by means of a reformer.

Since hydrogen is fed to the water-operated fuel cell in excess, the exhaust gas on the hydrogen side of the fuel cell usually still contains a residue of hydrogen. This hydrogen either passes into the environment or is returned to the system.

Particularly when the PEM fuel cell is operating with hydrogen-rich gas which has been produced by means of a reformer, from a liquid fuel, such as gasoline, methanol or higher hydrocarbons, returning is disadvantageous, since the residual fuel gas still contains a high level of noncombustible gases.

### SUMMARY OF THE INVENTION

It is accordingly an object of the invention to provide a fuel cell installation, which overcomes the above-mentioned disadvantages of the heretofore-known devices and methods of this general type and which provides for an alternative solution for the recycling of the hydrogen.

With the foregoing and other objects in view there is provided, in accordance with the invention, a fuel cell system, comprising:

at least one fuel cell module configured for operation with hydrogen or a hydrogen-rich gas, said fuel cell module having a stack with HT-PEM fuel cells, associated membrane electrode assemblies, and an exhaust gas side;

an exhaust-gas catalytic converter for catalytically converting at least one exhaust-gas constituent selected from the group consisting of hydrogen, carbon monoxide, and hydrocarbons present in an exhaust gas on the exhaust-gas side of said membrane electrode assemblies.

In other words, an exhaust-gas catalytic converter for hydrogen and/or carbon monoxide and/or hydrocarbon is assigned to an HT-PEM fuel cell module. If the HT-PEM fuel cell module is operated only with pure hydrogen, the exhaust-gas catalytic converter can be used specifically to render the excess hydrogen harmless and ensure that it does not pass into the environment. In this context, it is particularly advantageous that the thermal energy which is released at the catalytic converter, which generally operates exothermically, can be fed to the reformer connected upstream of the PEM fuel cell.

Catalytic converters which are known from the prior art are used as the exhaust-gas catalytic converter. An example of a particularly suitable hydrogen catalytic converter is a platinum mesh. A catalytic converter of this type may be electrically heated and may in particular be at the operating temperature of the HT-PEM fuel cell.

Other features which are considered as characteristic for the invention are set forth in the appended claims.

Although the invention is illustrated and described herein as embodied in a fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE shows a block diagram illustrating the operation of an HT-PEM fuel cell in combination with an exhaust-gas catalytic converter.

### DESCRIPTION OF THE PREFERRED EMBODIMENTS

Referring now to the sole FIGURE of the drawing in detail there is shown a fuel cell system 10. The system 10 of this type includes a fuel cell module 20 and associated auxiliary equipment. By way of example, a fuel cell module 20 which is constructed in the form of a PEM fuel cell is indicated. In this context, the acronym PEM stands for a fuel cell which is operated with hydrogen and oxygen and has solid electrolytes using the so-called proton exchange process (PEM stands for either Proton Exchange Membrane or Polymer Electrolyte Membrane), in which a polymer electrolyte layer forms the primary component of the fuel cell. There is in each case one membrane electrode assembly (MEA), at which the elemental reactions of hydrogen (H₂) and oxygen (O₂) to form water with the generation of electric charges take place. A large number of MEAs with associated bipolar plates are stacked to form a so-called fuel cell stack comprising elemental fuel cell units which are electrically connected in series; a corresponding voltage can be tapped from the stack.

The hydrogen for operating the HT-PEM fuel cell module 20 is generated from a liquid fuel, for example gasoline, methanol or other higher hydrocarbons, in a reformer 110 which is indicated in the FIGURE, or is taken from a non-illustrated hydrogen tank. The oxidizing agent is provided from the ambient air. Since hydrogen is present in excess, at the outlet of the hydrogen side of the membrane electrode assemblies of the fuel cell module 20 hydrogen is discharged to the environment. Hydrogen exhaust gases of this type are undesirable and need to be suppressed as far as possible.

In the FIGURE, the PEM fuel cell module 20 is assigned a hydrogen catalytic converter 25. The hydrogen in the exhaust gas from the HT-PEM fuel cell module 20 is rendered harmless by a catalytic converter of this type.

By way of example, a platinum mesh is used as exhaust-gas catalytic converter 25 for hydrogen (H₂). Since the chemical conversion of the hydrogen represents an exothermic process, thermal energy is released. The heat that is released is advantageously fed to the reformer 110. The feedback is schematically illustrated by a dashed line labeled Q. It is also possible for the exhaust-gas catalytic converter or the exhaust gas itself to be heated to the operating temperature of the fuel cell, in particular of the HT-PEM fuel cell module 20. A corresponding electrical heating device is schematically illustrated.

It has been found that, specifically in the case of a PEM fuel cell which is operated at temperatures of over 100° C. at standard pressure, i.e. a so-called HT-PEM fuel cell, the undesirable hydrogen exhaust gas can be rendered substantially harmless at the outlet of the fuel cell module.

To operate the HT-PEM fuel cell, it is also possible to use a hydrogen-rich fuel gas which is obtained, for example, from gasoline, methanol or other higher hydrocarbons and, as additional constituents, also contains impurities of carbon monoxide and/or hydrocarbons, which is advantageously tolerated when the HT-PEM fuel cell is operating. In this case, it may be advantageous, in the same way as specifically described for a catalytic converter for hydrogen (H₂) with reference to the FIGURE, also to provide catalytic converters for carbon monoxide and/or for hydrocarbons. This makes it possible to render harmful auxiliary constituents of this type in the fuel gas and in the exhaust gas harmless. This eliminates environmental pollution.

We claim:

1. A fuel cell system, comprising:
at least one fuel cell module configured for operation with hydrogen or a hydrogen-rich gas, said fuel cell module having a stack with HT-PEM fuel cells, associated membrane electrode assemblies, and an exhaust gas side;
an exhaust-gas catalytic converter for catalytically converting at least one exhaust-gas constituent selected from the group consisting of hydrogen, carbon monoxide, and hydrocarbons present in an exhaust gas on the exhaust-gas side of said membrane electrode assemblies.

2. The fuel cell system according to claim 1, wherein said fuel cell module is operated with pure hydrogen, and said exhaust-gas catalytic converter is an H₂ catalytic converter for preventing undesirable hydrogen emissions.

3. The fuel cell system according to claim 2, wherein said H₂ catalytic converter is a platinum mesh.

4. The fuel cell system according to claim 1, which comprises a device for electrically heating said exhaust-gas catalytic converter.

5. The fuel cell system according to claim 1, wherein said exhaust-gas catalytic converter is an exothermally operating catalytic converter.

6. The fuel cell system according to claim 5, which comprises a feedback for feeding exothermic thermal energy of said exhaust-gas catalytic converter to said reformer.

7. The fuel cell system according to claim 1, which comprises a reformer connected at an inlet side of said fuel cell module, said reformer producing hydrogen or a hydrogen-rich fuel gas from a liquid fuel.

8. The fuel cell system according to claim 7, which comprises a feedback for feeding exothermic thermal energy of said exhaust-gas catalytic converter to said reformer.
